(19) United States
(12) Patent Application Publication
(10) Pub. No.: US 2008/0283169 A1
(43) Pub. Date: Nov. 20, 2008

(54) Pneumatic Tire

(75) Inventors: Yoshiki Sato, Osaka (JP); Takashi Nakatsuru, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/030,588

(22) Filed: Feb. 13, 2008

(30) Foreign Application Priority Data
Feb. 22, 2007 (JP) 2007-42830
Apr. 3, 2007 (JP) 2007-97105
Apr. 5, 2007 (JP) 2007-99176

(51) Int. Cl. B60C 5/00

(52) U.S. Cl. 152/450

(57) ABSTRACT

A pneumatic tire is provided in which markings shown on surfaces of side walls thereof have superior visibility and the effect of increased visibility can be maintained over a long period of time. In a pneumatic tire having a marking provided on a side wall, a marking area which includes the marking and a background portion of the marking is formed into a recessed plane which is recessed further inwards than the surface of the side wall in an axial direction of the tire, and the marking is formed in the marking area in the form of a projecting plane which is provided in such a manner as to project relative to the recessed plane. The surface of the marking is made up of a specular surface portion having a surface roughness in which a center line average surface roughness (Ra) is in the range of 0.4 to 1.5 μm, and the background portion is made up of a rough surface portion whose surface roughness exceeds a surface roughness in which Ra is 1.5 μm.

### BACKGROUND OF THE INVENTION

1. Field of the Invention

The present invention relates to a pneumatic tire and more particularly to a pneumatic tire having provided on the surfaces of side walls thereof markings such as letters, numbers, symbols or graphics which are superior in visibility.

2. Description of Background Art

Conventionally, markings are shown on the surfaces of side walls of a tire which are made up of letters, numbers and symbols which designate a manufacturer, a trade name, a tire size and the like, as well as graphics such as design patterns which indicate the rotational direction of the tire and make the sides of the tire appear better.

Normally, markings are caused to protrude from the surfaces of the side walls for display. In addition, a large number of fine grooves called ridges are formed on the surfaces of the side walls in such a manner as to make up decorative elements, so that markings such as letters are shown by the decorative elements. For example, in JP-A-11-20416, ridges were formed only for letters making up markings, so as to indicate the markings by making use of difference in degree of reflection of light between the ridged markings and their background where no ridge was formed, or different ridges were formed for markings and their background which surrounds the markings so as to increase the visibility of the markings.

In the case of the markings being made up of the ridges, however, when a tire was used for a long period of time, minute foreign particles such as dust and dirt such as oil were accumulated in bottoms of the ridges, whereby the surface or visual appearance of the tire was deteriorated and the visibility of the markings was decreased. Furthermore, it was not easy for dust and dirt which were accumulated in the bottoms of the fine ridges to wash out, and the complicated and troublesome work was necessary to remove scale such as of a parting agent which was deposited in the bottoms of grooves formed on a mold.

In addition, as techniques for increasing the visual appearance of a tire, there have conventionally been proposed various techniques which include a technique described in JP-A-2000-142026 in which the glossiness of the surfaces of a tire is increased by specifying the surface roughness thereof to 1.5 to 20 μm, a technique described in JP-A-2003-252012 in which the surface roughness of a tire is specified to a relatively large range of 5 to 500 μm, so that light is diffused on the roughened surface portions of the tire so as to make the surfaces of the tire appear more blackish in tone, and a technique described in JP-A-2004-17964 in which the surface roughness of a tire is made very small so as to extremely increase the glossiness of the surfaces of the tire, and the diffusion of an additive over the surfaces is delayed so as to improve the visual appearance of the tire.

However, in the techniques in which the surface roughness of the tire is specified, a molding surface of a mold for a tire was adjusted to the specified roughnesses by shot blasting abrasive grains as of metal or glass beads against the molding surface, and the techniques were suitable for roughness adjustment over a relatively wide area on sides of a tire but had difficulty in adjusting the surface roughness of specific portions on side walls of the tire where markings were provided, in particular, portions where fine letters and/or graphics were provided to a specific surface roughness no matter how well abrasive grains and shot blasting conditions might be selected. In addition, when the surface roughness was made very small so as to increase the glossiness, there sometimes occurred a case where conspicuous marring tended to be easily made on the side of the tire in the event that the tire was brought into contact with a curb, for example, to thereby call for deterioration in visual appearance unintentionally.

### BRIEF SUMMARY OF THE INVENTION

The invention was made in view of the problems, and an object thereof is to provide a pneumatic tire having shown on the surfaces of side walls thereof markings which have superior visibility and which are made to prevent the adhesion of dust and dirt thereto and are made difficult to be subjected to external damage so as to maintain a good visible appearance of the tire for a long period of time to thereby make it possible for the effect of increased visibility of the markings to continue for a long period of time.

In addition, another object of the invention is to provide a pneumatic tire which can increase the visible appearance thereof by imparting different reflectivenesses to exterior surfaces of side wall portions thereof.

The inventor has made every possible effort in studying for solutions to the problems and found that the problems can be solved by providing a specular surface portion having a specified surface roughness on markings showing areas on the surfaces of sides of a tire and devising the height of the specular surface portion in an axial direction of the tire.

Namely, according to a first aspect of the invention, there is provided a pneumatic tire including a specular surface portion having a surface roughness in which a center line average surface roughness (Ra) is in the range of 0.4 to 1.5 μm and a rough surface portion in which an Ra exceeds 1.5 μm, the specular surface portion and the rough surface portion being provided partially on exterior surfaces of side walls thereof.

According to a second aspect of the invention, there is provided a pneumatic tire as set forth in the first aspect of the invention, wherein markings are provided on the side walls, a marking area which includes the marking and a background portion of the marking is formed into a recessed plane which is recessed further inwards than the surface of the side wall in an axial direction of the tire, and the specular surface portion is provided at least in part of the marking area.

In addition, according to a third aspect of the invention, there is provided a pneumatic tire as set forth in the first aspect of the invention, wherein a plurality of elongated recesses which continuously extend and each have a curved cross section is formed in such a manner as to be aligned in parallel at least partially on the exterior surfaces of the side walls, at least bottom surfaces of the curved portions include the specular surface portion, and the exterior surface of the elongated recess formed area which excludes the specular surface portions includes the rough surface portion.

Furthermore, according to a fourth aspect of the invention, there is provided a pneumatic tire as set forth in the first aspect of the invention, wherein an irregular portion in which recesses and projections are formed alternately is formed at least partially on the exterior surfaces of the side walls, at least part of the surface of the recess includes the specular surface portion, and a peripheral area which surrounds the specular surface portion includes the rough surface portion.

### BRIEF DESCRIPTION OF THE DRAWINGS

FIG. 1 is a partial perspective view of a tire of a first embodiment which is cut in half,

FIG. 2 is a sectional view taken along the line X-X in FIG. 1,

FIG. 3 is a partial perspective view of a tire of a second embodiment which is cut in half,

FIG. 4 is a sectional view taken along the line Y-Y in FIG. 3,

FIG. 5 is a partial perspective view of a tire of a third embodiment which is cut in half,

FIG. 6 is a partial sectional view taken along the line X-X in FIG. 5,

FIG. 7 is a partial sectional view taken along the line X-X in FIG. 5 which shows another example of a cross section as Example 1,

FIG. 8 is a partial sectional view taken along the line X-X in FIG. 5 which shows a further example of a cross section as Example 2,

FIG. 9 is a partial sectional view taken along the line X-X in FIG. 5 which shows an example of a cross section as Example 3,

FIG. 10 is a partial sectional view taken along the line Y-Y in FIG. 5,

FIG. 11 is a partial sectional view of a side wall of a tire of Comparison Example 5

FIG. 12 is a partial sectional view of a side wall of a tire of Comparison Example 10,

FIG. 13 is a side view of a tire of a fourth embodiment,

FIG. 14 is an explanatory view which illustrates an irregular state of a portion where recesses and projections are provided,

FIG. 15 is a partial sectional view taken along the line X-X in FIG. 14,

FIG. 16 is an explanatory view which illustrates an irregular state of a portion where recesses and projections are provided according to Modified Example 1,

FIG. 17 is a partial sectional view taken along the line Y-Y in FIG. 16,

FIG. 18 is an explanatory view which illustrates Modified Example 2 in which an apex of a quadrangular pyramid is placed eccentrically,

FIG. 19 is an explanatory view which illustrates an irregular state of a portion where recesses and projections are provided according to Modified Example 3, and

FIG. 20 is an explanatory view which illustrates an irregular state of a portion where recesses and projections are provided according to Modified Example 4,

### DETAILED DESCRIPTION OF THE INVENTION

Hereinafter, referring to the drawings, embodiments of the invention will be described.

### First Embodiment

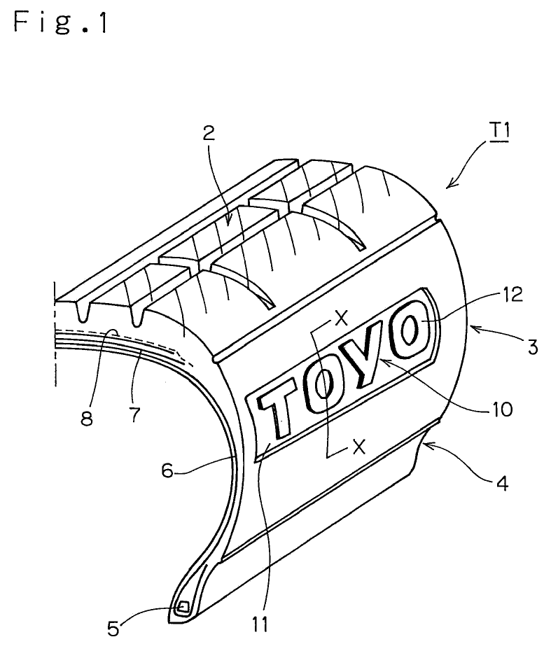

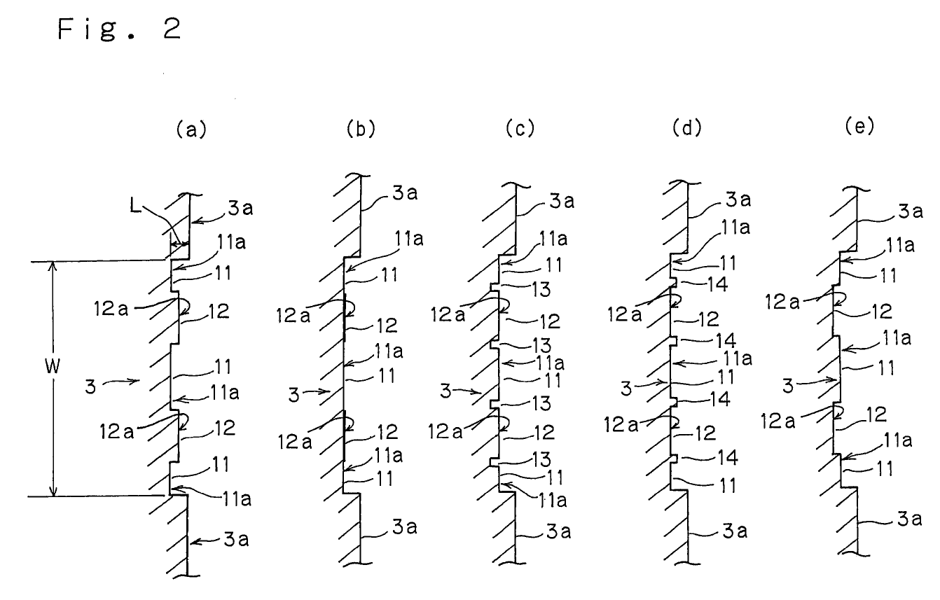

FIG. 1 is a partial perspective view of a tire which is cut in half which shows a surface of a side wall of a pneumatic tire T1 (hereinafter, the pneumatic tire may simply be referred to as a “tire.”) which constitutes a first embodiment of the invention, and FIGS. 2A to 2E show sectional views taken along the line X-X in FIG. 1. In FIGS. 2A to 2E, a curved plane on the surface of the side wall is shown as being deployed into a flat plane as a matter of convenience.

A passenger vehicle radial tire is illustrated as the tire T1 which is made up of a tread portion 2, side walls 3 which extends radially inwards from both edges of the tread portion 2, and bead portions 4 which continue to inner edges of the side walls 3 and which are secured to rim flanges, and in this embodiment, the tire T1 has a carcass 6 having a radial construction in which edges of carcass plies are turned round bead cores 5, a belt layer 7 which is provided on an outer circumference of the carcass 6 in a portion which corresponds to the tread portion 2 and a belt reinforcement layer 8 which is wound round an outer circumference of the belt layer 7.

Markings 12 are shown on surfaces of the side walls 3 which are made up of letters, numbers and symbols which show a manufacturer, a trade name, a tire size and the like, as well as graphics which are design patterns which show a rotational direction of the tire and dress up the sides of the tire. In FIG. 1, as the markings 12, a line of letters (TOYO) is shown in the form of carved letters.

A background portion 11, which is made up of a plain surface, is provided to surround the peripheries of the markings 12 so as to constitute a background which increases the visibility of the markings 12, and the markings 12 and the background portion 11 form a marking area 10.

In the tire T1, the marking area 10 is defined by a recessed flat plane which is recessed further inwards than a surface 3a of the side wall 3 in an axial direction of the tire.

A depth L of the marking area 10 relative to the side wall surface 3a in the axial direction of the tire and a width W thereof in a radial direction of the tire are not limited to any specific depth and width, but for example, a depth of the order of 0.5 to 3.0 mm and a width of the order of 4 to 40 mm are illustrated as preferred ranges (refer to FIG. 2A).

In the event that the depth L is less than 0.5 mm, marring is easily made on the markings 12 when the tire T1 is brought into contact with a curb, whereas the depth L exceeds 3.0 mm, stress is concentrated at bottom edge portions of the recessed plane formed while the vehicle is running, whereby cracks are easily produced in the portions concerned. In addition, in the event that the width W is less than 4 mm, the width of the marking area 10 becomes narrow, which inevitably reduces the area of a marking portion, whereby it becomes difficult to obtain the effect of increased visibility, whereas in the event that the width W exceeds 40 mm, the marking portion is easy to be subjected to external damage by a curb or the like, the visible appearance of the tire being thereby reduced.

In the tire T1, surface portions 12a of the markings 12 are made up of a specular surface having a surface roughness in which a center line average surface roughness (Ra) is in the range of 0.4 to 1.5 μm, and the background portion 11 is made up of a rough surface whose surface roughness exceeds a surface roughness in which Ra exceeds 1.5 μm.

By this configuration, the light reflectiveness at the marking area 10 is made to differ between the surface portions 12 of the markings 12 which are made up of the specular surface and a surface 11a of the background portion 11 which is made up of the rough surface due to a difference in glossiness therebetween, whereby the markings 12 can be made conspicuous to thereby increase the visibility thereof.

Although the Ra of the specular surface portion is set to the range of 0.4 to 1.5 μm, in the event that the Ra is less than 0.4 μm, the light reflectiveness at the marking surfaces 12a becomes large and hence tends to glitter, whereby the markings 12 sometimes look white so as to decrease the visibility of the markings 12 unintentionally. In addition, although mud, oil or the like becomes easy to wash out when they adhere to the marking surfaces, small exterior damage such as a scratch or scrape produced by scratching or scraping by the curb becomes easy to be conspicuous. Furthermore, a special surface treatment (for example, a surface treatment by plating with chrome or the like) is necessary to be made on a tire molding mold, which is not preferable because the tire production costs are increased. In contrast, in the event that the Ra exceeds 1.5 μm, minute foreign particles such as dust or dirt such as oil enters fine irregularities on the marking surfaces, and once they so enter, dust and dirt become hard to wash out and hence continue to remain on the marking surfaces, whereby the visible appearance as the specular surface portion is deteriorated.

Additionally, the difference in Ra between the surface 12a of the marking which is made up of the specular surface and the surface 11a of the background portion which is made up of the rough surface is preferably 1 μm or more. In the event that the difference is 1 μm or more, there can be obtained a distinct difference in glossiness therebetween, thereby making it possible to enhance the visibility of the marking 12 effectively.

Although no specific upper limit is imposed on the Ra of the rough surface portion, the Ra is preferably less than 2 μm. In the event that the Ra becomes 2 μm or more, the surface gets satinized and the irregularity on the rubber surface is increased to facilitate the adhesion of dust or the like thereto, and the surface also gets disadvantageous with respect to resistance to ozone, facilitating the generation of ozone cracks through service over a long period of time.

The surface roughness (Ra) is a center line average roughness of the degree of surface irregularity of an area per unit length which is measured using a contact profile meter in compliance with the provisions of JIS B0601 (a contact profile meter).

The Ra of the marking area 10 can be formed by a tire vulcanizing mold having a molding surface provided with a surface roughness which is substantially equal to the surface roughness of the tire. Namely, the surface roughness of the mold is transferred on to exterior surface of a tire with substantially the same surface roughness through vulcanization molding.

The surface roughness of the molding surface of the mold can be adjusted by the use of a known method such as the shot blast method, the specular surface polishing method or a combination thereof.

The tire T1 of the embodiment of the invention may be such that the portions of the markings 12 are defined by projecting planes which are provided to project from the surface of the marking area 10 which is provided in such a manner as to be recessed from the surface of the sidewall. In addition, the tire T1 of the embodiment of the invention may be such that the markings 12 and the background portion 11 are formed on the same plane in the marking area 10 while being divided into portions made up of the specular surface and a portion made up of the rough surface.

An example shown in FIG. 2A is such that a marking area 10 is defined by a recessed flat plane which is provided in such a manner as to be recessed further inwards than the surface of a side wall 3 in an axial direction of a tire and a marking 12 (a vertical sectional portion of a letter, “O”) is defined by a projecting plane which is provided in such a manner as to project relative to a background portion 11. A surface 12a of the marking 12 is made up of a specular surface portion having a surface roughness in which Ra is in the range of 0.4 to 1.5 μm, while the background portion 11 is made up of a rough surface portion in which Ra exceeds 1.5 μm.

A projecting height of the marking 12 is preferably set such that the marking 12 is provided further inwards than a side wall surface 3a in the axial direction of the tire, whereby the marking surface 12a can be made difficult to be subjected to exterior damage. As this occurs, the projecting height is preferably in the range of 20 to 80% of a depth L of the recessed plane.

According to the configuration described above, by forming the marking 12 into a letter in high relief, the glossiness of the marking surface 12a which is made up of the specular surface can be made to look as standing out within the marking area 10 which is made up of the rough surface, whereby the marking 12 can be made to look conspicuous, thereby making it possible to increase the visibility thereof.

Additionally, an example shown in FIG. 2B is such that a marking 12 and a background portion 11 are formed on the same plane within a marking area 10, and a surface of the marking 12 is made up of a specular surface 12a, while a surface of the background portion 11 is made up of a rough surface so that the marking 12 and the background portion 11 are discriminated from each other, and in this configuration, no crack is produced which would otherwise be produced, due to stress concentrated, in an edge portion from which a projecting portion rises when the marking 12 is provided in such a manner as to project from the marking area 10.

In addition, an example shown in FIG. 2C is such that a marking 12 and a background portion 11 are formed on the same plane within a marking area 10, and a surface of the marking 12 is made up of a specular surface 12a, while a surface of the background portion 11 is made up of a rough surface, with thin grooves 13 provided on the periphery of the marking 12 (a letter) so as to discriminate the marking 12 from the background portion 11, whereby the glossiness of the marking surface 12a made up of the specular surface can be made to stand out further from the background portion 11 made up of the rough surface by being discriminated from the background portion 11 via the shaded portion made up of the fine grooves 13.

Additionally, an example shown in FIG. 2D is such that a marking 12 and a background portion 11 are formed on the same plane within a marking area 10, and a surface of the marking 12 is made up of a specular surface 12a, while a surface of the background portion 11 is made up of a rough surface, with elongated projections 14 provided on the periphery of the marking 12 (a letter) so as to discriminate the marking 12 from the background portion 11, whereby the same advantage as that of the example shown in FIG. 2C can be obtained, and furthermore, the elongated projections 14 function to protect the marking area 10, thereby making it possible to enhance the resistance to exterior damage.

In addition, an example shown in FIG. 2E is such that a marking area 10 is defined by a recessed flat plane which is provided in such a manner as to be recessed further inwards than the surface of a side wall 3 in an axial direction of a tire and a marking 12 is defined by a recessed plane which is provided in such a manner as to be recessed further inwards than a background portion 11. A surface portion 12a of the marking 12 is made up of a specular surface, while the background portion 11 is made up of a rough surface.

According to this configuration, by forming the marking 12 into a letter which is carved inwards, the glossiness of the marking surface 12a which is made up of the specular surface is made to sink below the marking area 10 which is made up of the rough surface so as to give an impression that the marking 12 glitters at the bottom of the marking area 10, whereby not only is the visibility of the marking 12 enhanced but also the marking 12 is made difficult to be subjected to exterior damage. Furthermore, since a molding surface of a mold for molding the marking surface 12a is made up of a projecting plane, polishing work of a specular surface formed on the projecting plane is facilitated.

Note that while in this embodiment, the line of letters, “TOYO,” is shown by solid letters which have no rim provided along perimeters thereof, the letters may, of course, be shown by rimmed letters.

### Second Embodiment

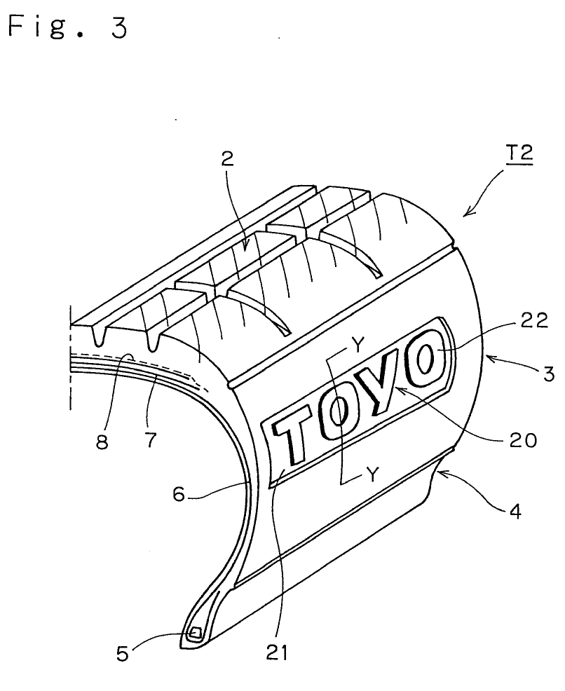

FIG. 3 is a partial perspective view of a tire which is cut in half which shows a surface of a side wall of a tire T2 which constitutes a second embodiment of the invention, and FIGS. 4A to 4E show sectional views taken along the line X-X in FIG. 3. In FIGS. 4A to 4E, a curved plane on the surface of the side wall is shown as being deployed into a flat plane as a matter of convenience.

A passenger vehicle radial tire is illustrated as the tire T2 which has the same interior construction as that of the tire T1 (like reference numerals being imparted to like portions and like members to those of the tire T1). Markings 22 are shown on surfaces of side walls 3 which are made up of letters, numbers and symbols which show a manufacturer, a trade name, a tire size and the like, as well as graphics which are design patterns which show a rotational direction of the tire and dress up the sides of the tire. In FIG. 3, as the markings 22, a line of letters (TOYO) is shown in the form of carved letters.

A background portion 21 is provided to surround the peripheries of the markings 22 so as to constitute a background which increases the visibility of the markings 22, and the markings 22 and the background portion 21 form a marking area 20.

In the tire T2, the marking area 20 is defined by a recessed flat plane which is recessed further inwards than a surface 3a of the side wall 3 in an axial direction of the tire.

A depth L of the marking area 20 relative to the side wall surface 3a in the axial direction of the tire and a width W thereof in a radial direction of the tire are not limited to any specific depth and width, and as with the first embodiment, for example, a depth of the order of 0.5 to 3.0 mm and a width of the order of 4 to 40 mm are illustrated as preferred ranges (refer to FIG. 4A), and the reasons for adopting those depth and width ranges are the same as those of the first embodiment.

In the tire T2, surface portions 22a of the markings 22 are made up of a rough surface whose surface roughness exceeds a surface roughness in which Ra exceeds 1.5 μm, and the background portion 21 of the markings 22 is made up of a specular surface having a surface roughness in which Ra is in the range of 0.4 to 1.5 μm.

By this configuration, the light reflectiveness at the marking area 20 is made to differ between a surface 21a of the background portion 21 which is made up of the specular surface and the surface portions 22a of the markings 22 which are made up of the rough surfaces due to a difference in glossiness therebetween, and by giving the glossiness to the background portion 21, the markings 22 can be made to look as if they stood out within the marking area 20, thereby making it possible to increase the visibility thereof.

The Ra of the specular surface portion is set to the range of 0.4 to 1.5 μm. In the event that the Ra is less than 0.4 μm, although mud, oil or the like becomes easy to wash out when they adhere to the surface 21a of the background portion 21, the surface 21a becomes easy to be subjected to small exterior damage such as a scratch or scrape produced by scratching or scraping by a curb, and once such marring is made thereon, the marring becomes easily conspicuous. Furthermore, a special surface treatment (for example, a surface treatment by plating with chrome or the like) is necessary to be made on a tire molding mold, which is not preferable because the tire production costs are increased. In contrast, in the event that the Ra exceeds 1.5 μm, minute foreign particles such as dust or dirt such as oil enters fine irregularities on the marking surfaces, and once they so enter, dust and dirt become hard to wash out and hence continue to remain on the marking surfaces, whereby the visible appearance as the specular surface portion is deteriorated.

Additionally, the difference in Ra between the surface 22a of the marking 22 which is made up of the rough surface and the surface 21a of the background portion 21 which is made up of the specular surface is preferably 1 μm or more. In the event that the difference is 1 μm or more, there can be obtained a distinct difference in glossiness therebetween, thereby making it possible to enhance the visibility of the marking 22.

The Ra of the marking area 20 can be formed by a tire vulcanizing mold having a molding surface provided with a surface roughness which is substantially equal to the surface roughness of the tire. Namely, the surface roughness of the mold is transferred on to exterior surface of a tire with substantially the same surface roughness through vulcanization molding.

The surface roughness of the molding surface of the mold can be adjusted by the use of a known method such as the shot blast method, the specular surface polishing method or a combination thereof.

In addition, since a portion of a tire mold which corresponds to the background portion 21 is formed into a projecting plane, polishing work becomes easy to be carried out on the surface of the portion concerned of the mold, and furthermore, maintenance work is facilitated which includes a re-polishing for removing scale of parting agent which deposits on the surface of the mold through vulcanization molding of a tire. Thus, an increase in tire productivity and maintenance efficiency can be realized.

The tire T2 of the embodiment of the invention may be such that the portions of the markings 22 are defined by projecting planes which are provided to project from the surface of the marking area 20 which is provided in such a manner as to be recessed from the surface of the sidewall. In addition, the tire T2 of the embodiment of the invention may be such that the markings 22 and the background portion 21 are formed on the same plane in the marking area 20 while being divided into portions made up of the rough surface and a portion made up of the specular surface.

An example shown in FIG. 4A is such that a marking area 20 is defined by a recessed flat plane which is provided in such a manner as to be recessed further inwards than a surface 3a of a side wall 3 in an axial direction of a tire and a marking 22 (a vertical sectional portion of a letter, “O”) is defined by a projecting plane which is provided in such a manner as to project relative to a background portion 21. A surface 22a of the marking 22 is made up of a rough surface portion having a surface roughness in which Ra exceeds 1.5 μm, while the background portion 21 is made up a specular surface portion having a surface roughness in which Ra is in the range of 0.4 to 1.5 μm.

However, a projecting height of the marking 22 is preferably set such that the marking 22 is provided further inwards than the side wall surface 3a in the axial direction of the tire, whereby the marking surface 22a can be made difficult to be subjected to exterior damage. As this occurs, the projecting height is preferably of the order of 20 to 80% of a depth L of the recessed plane.

According to the configuration described above, by forming the marking 22 into a letter in high relief, the marking surface 22a which is made up of the rough surface can be made to look as standing out conspicuously in an accentuated fashion within the marking area 20 which is made up of the specular surface having the glossiness. In addition, an effect is expected to be provided that the scenery surrounding the tire or the like is reflected on the background portion 21 so as to enhance further the visible appearance of the tire.

Additionally, an example shown in FIG. 4B is such that a marking 22 and a background portion 21 are formed on the same plane within a marking area 20, and a surface of the marking 22 is made up of a rough surface 22a, while a surface of the background portion 21 is made up of a specular surface so that the marking 22 and the background portion 21 are discriminated from each other, and in this configuration, no crack is produced which would otherwise be produced, due to stress concentrated, in an edge portion from which a projecting portion rises when the marking 22 is provided in such a manner as to project from the marking area 20.

In addition, an example shown in FIG. 4C is such that a marking 22 and a background portion 21 are formed on the same plane within a marking area 20, and a surface of the marking 22 is made up of a rough surface 22a, while a surface of the background portion 11 is made up of a specular surface, with thin grooves 23 provided on the periphery of the marking 22 (a letter) so as to discriminate the marking 22 from the background portion 21, whereby the marking surface 22a made up of the rough surface can be made to look as if it stood out from the background portion 21 made up of the specular surface by being discriminated from the background portion 21 via the shaded portion made up of the fine grooves 23.

Additionally, an example shown in FIG. 4D is such that a marking 22 and a background portion 21 are formed on the same plane within a marking area 20, and a surface of the marking 22 is made up of a rough surface 22a, while a surface of the background portion 21 is made up of a specular surface, with elongated projections 24 provided on the periphery of the marking 22 (a letter) so as to discriminate the marking 22 from the background portion 21, whereby the same advantage as that of the example shown in FIG. 4C can be obtained, and furthermore, the elongated projections 24 function to protect the marking area 20, thereby making it possible to enhance the resistance to exterior damage.

In addition, an example shown in FIG. 4E is such that a marking area 20 is defined by a recessed flat plane which is provided in such a manner as to be recessed further inwards than the surface of a side wall 3 in an axial direction of a tire and a marking 22 is defined by a recessed plane which is provided in such a manner as to be recessed further inwards than a background portion 21. A surface portion 22a of the marking 22 is made up of a rough surface, while the background portion 21 is made up of a specular surface.

According to this configuration, by forming the marking 22 into a letter which is carved inwards, the marking surface 22a which is made up of the rough surface is made to sink below the marking area 20 which is made up of the specular surface so as to give an impression that there exists a certain depth to thereby accentuate the glossiness of the background portion 21, whereby not only is the visibility of the marking 22 enhanced but also a surface portion 22a of the marking 22 is made difficult to be subjected to exterior damage.

### Third Embodiment

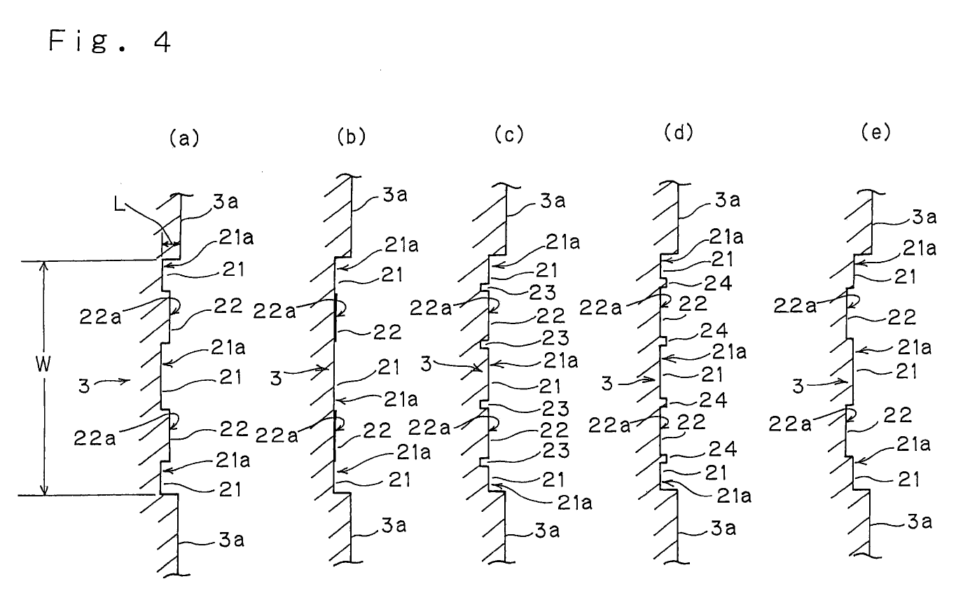

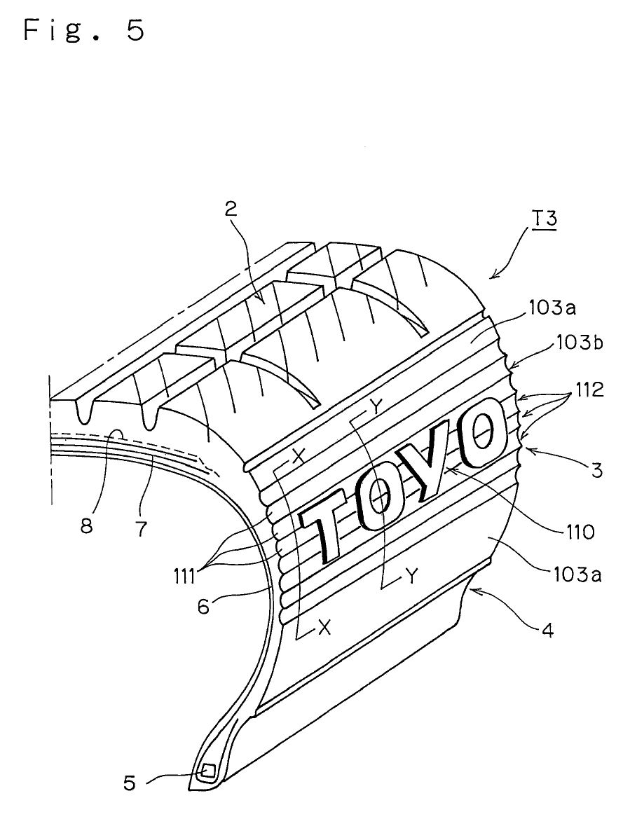

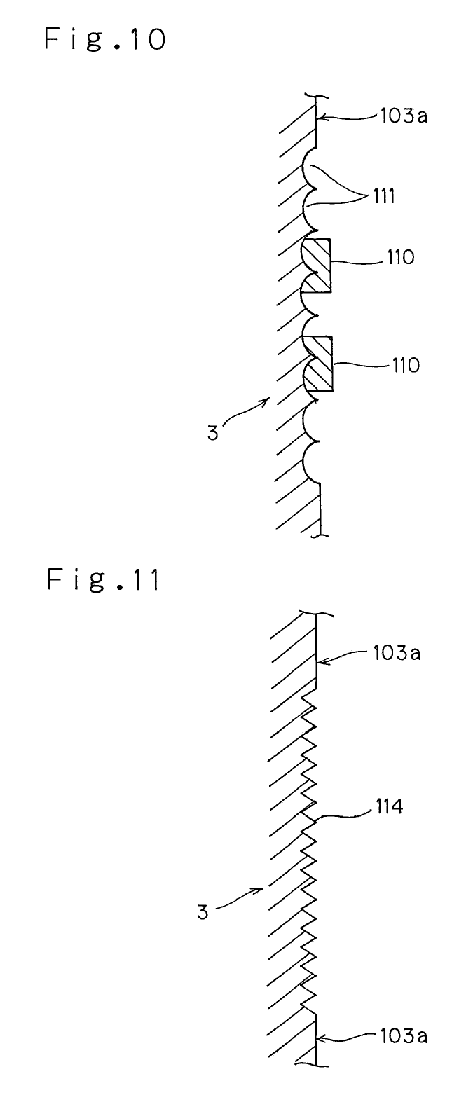

FIG. 5 is a partial perspective view of a tire which is cut in half which shows a surface of a side wall of a pneumatic tire T3 which constitutes a third embodiment of the invention, FIGS. 6 to 9 show sectional views taken along the line X-X in FIG. 5, and FIG. 10 is a sectional view taken along the line Y-Y in FIG. 5. In FIGS. 6 to 10, a curved plane on the surface of the side wall is shown as being deployed into a flat plane as a matter of convenience.

A passenger vehicle radial tire is illustrated as the tire T3 which is made up of a tread portion 2, side walls 3 which extends radially inwards from both edges of the tread portion 2, and bead portions 4 which continue to inner edges of the side walls 3 and which are secured to rim flanges, and in this embodiment, the tire T1 has a carcass 6 having a radial construction in which edges of carcass plies are turned round bead cores 5, a belt layer 7 which is provided on an outer circumference of the carcass 6 in a portion which corresponds to the tread portion 2 and a belt reinforcement layer 8 which is wound round an outer circumference of the belt layer 7.

A plurality of elongated recesses 111 are formed to be aligned in parallel on external surfaces of side wall portions 3 of the tire T3 in such a manner as to extend continuously in a circumferential direction of the side wall portions 3. In FIG. 5, markings 110 which are shown by a line of letters (TOYO) are carved in the vicinity of a maximum width area of the tire, and eight elongated recesses 111 are provided with the line of letters positioned in the center thereof.

As is shown in FIG. 6, a curved portion 112 is formed on an inner surface of the elongated recess 111, and a bottom surface portion of the curved portion 112 is made up of a specular surface whose center line average surface roughness (Ra) is in the range of 0.4 to 1.5 μm, while an exterior surface of an elongated recess formed area 103b which excludes the specular surfaces portions and side wall portions 103a which hold the marking area 110 and the elongated recess formed area 103b therebetween are made up of a rough surface whose Ra exceeds 1.5 μm.

Here, no specific limitation is imposed on the surface properties of the side wall portions 103a other than the elongated recess formed area 103b, and hence, the side wall portions 103a may be made up of the rough surface or the specular surface. However, from the viewpoint of making conspicuous the specular surfaces of the curved portions 112, the side wall portions 103a are preferably made up of the rough surface which constitutes a contrast to the specular surface.

By this configuration, the light reflectiveness at the side wall portions 103a is made to differ between the curved portions 112 of the elongated recesses 111 which are made up of the specular surface and the remaining portion of the elongated recess formed area 103b which excludes the specular surface portions and which is made up of the rough surface due to a difference in glossiness therebetween, whereby the visible appearance of the side wall portion 3 can be enhanced. Furthermore, this effect can be increased by making up the side wall portions 103a of the rough surface.

Although the Ra of the specular surface portion is set to the range of 0.4 to 1.5 μm, in the event that the Ra is less than 0.4 μm, the light reflectiveness at the curved portions 112 becomes large and hence they tend to glitter to thereby look white, so as to decrease the visible appearance of the side wall portion 3 unintentionally. In addition, although mud, oil or the like becomes easy to wash out when they adhere to the curved portions 112, small exterior damage such as a scratch or scrape produced by scratching or scraping by a curb becomes easy to be conspicuous. Furthermore, a special surface treatment (for example, a surface treatment by plating with chrome or the like) is necessary to be made on a tire molding mold, which is not preferable because the tire production costs are increased. In contrast, in the event that the Ra exceeds 1.5 μm, minute foreign particles such as dust or dirt such as oil enters fine irregularities on the marking surfaces, and once they so enter, dust and dirt become hard to wash out and hence continue to remain on the marking surfaces, whereby the visible appearance as the specular surface portion is deteriorated.

Additionally, the difference in Ra between the curved portions 112 which are made up of the specular surface and the other rough surface portion is preferably 1 μm or more. In the event that the difference is 1 μm or more, there can be obtained a distinct difference in glossiness therebetween, whereby the visible appearance of the elongated recess formed area 103b is increased effectively, thereby making it possible to enhance the visible appearance of the tire.

Although no specific upper limit is imposed on the Ra of the rough surface portion, the Ra is preferably less than 2 μm. In the event that the Ra becomes 2 μm or more, the surface gets satinized and the irregularity on the rubber surface is increased to facilitate the adhesion of dust or the like thereto, and the surface also gets disadvantageous with respect to resistance to ozone, facilitating the generation of ozone cracks through service over a long period of time.

In the elongated recess 111, a range where the specular surface in which the Ra is in the range of 0.4 to 1.5 μm is formed may be extended over the whole of the curved portion 112, or the specular surface may be formed over a predetermined width which is defined about the bottom surface of the curved portion 112, for example, a width which corresponds to 40 to 90% of the curved portion 112. However, the specular surface is preferably formed as wide as possible with a view to securing the glossiness.

The Ra of the elongated recesses 111 can be formed by a tire vulcanizing mold having a molding surface provided with a surface roughness Ra which is substantially equal to the surface roughness of the tire. Namely, the Ra of the mold is transferred on to exterior surface of a tire with substantially the same Ra through vulcanization molding.

The Ra of the molding surface of the mold can be adjusted by the use of a known method such as the shot blast method, the specular surface polishing method or a combination thereof.

In addition, since portions of the tire mold which correspond to the elongated recesses 111 are formed into elongated projections, polishing work becomes easy to be carried out on the surface of the portions concerned of the mold, and furthermore, maintenance work is facilitated which includes a re-polishing for removing scale of parting agent which deposits on the surface of the mold through vulcanization molding of a tire. Thus, an increase in tire productivity and maintenance efficiency can be realized.

Although a depth L of the elongated recess 111 in the axial direction of the tire from the side wall surface 3a to the curved bottom portion thereof and a width W thereof in a radial direction of the tire are not limited to any specific depth and width, but for example, a depth of the order of 0.5 to 2.0 mm and a width of the order of 4 to 30 mm are illustrated as preferred ranges.

In the event that the depth L is less than 0.5 mm, marring is easily made on the bottom portion of the elongated recess 111 when the tire T3 is brought into contact with a curb, whereas the depth L exceeds 2.0 mm, stress which is applied repeatedly to the side wall portions 3 while the vehicle is running is concentrated at the bottom portions of the elongated recesses 111, whereby cracks are easily produced in the portions concerned. In addition, in the event that the width W is less than 4 mm, the width of the curved glossy area becomes narrow, which inevitably reduces the area of a marking portion, whereby it becomes difficult to obtain the effect of increased visible appearance, whereas in the event that the width W exceeds 30 mm, the glossy area is easy to be subjected to exterior damage by a curb or the like, the visible appearance of the tire being thereby reduced.

The plurality of elongated recesses 111 may be such that elongated recesses having the same sectional configuration are aligned in the manner described above. Alternatively, the elongated recesses 111 may be such that elongated recesses having different sectional configurations may be aligned at random. In addition, the elongated recesses 111 may be such that the depth L and width W thereof may be made to increase or decrease sequentially towards the radial direction of the tire.

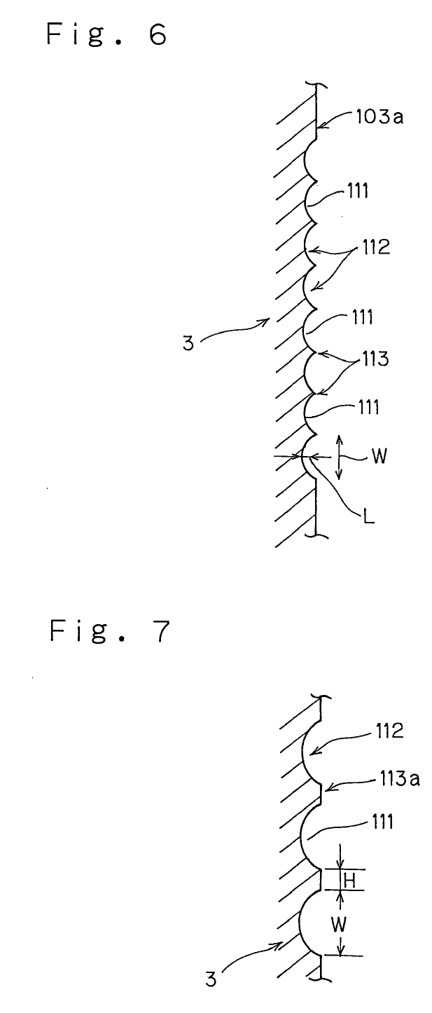

In addition, projecting boundary portions 113 between the elongated recesses 111 may be formed into an acute angular shape so that the elongated recesses 111 are provided continuously as is shown in FIG. 6, or flat-topped projecting portions 113a may be provided between elongated recesses 111 which are aligned in parallel as is shown in FIG. 7. Alternatively, as with projecting portions 113b shown in FIG. 8, elongated recesses 111 may be adopted in which the projecting height of the projecting portions is set such that the projecting portions are positioned further inwards than a side wall surface 113a in the axial direction of the tire.

When the elongated recesses 111 have the flat-topped projecting portions 113a, 113b, a ratio H/W of the width W of the elongated recess 111 to the width H of the projecting portions 113a, 113b is preferably less than 0.5. In the event that H/W becomes 0.5 or more, the glossy surface of the elongated recess 111 is reduced, and the advantage of the invention is damaged.

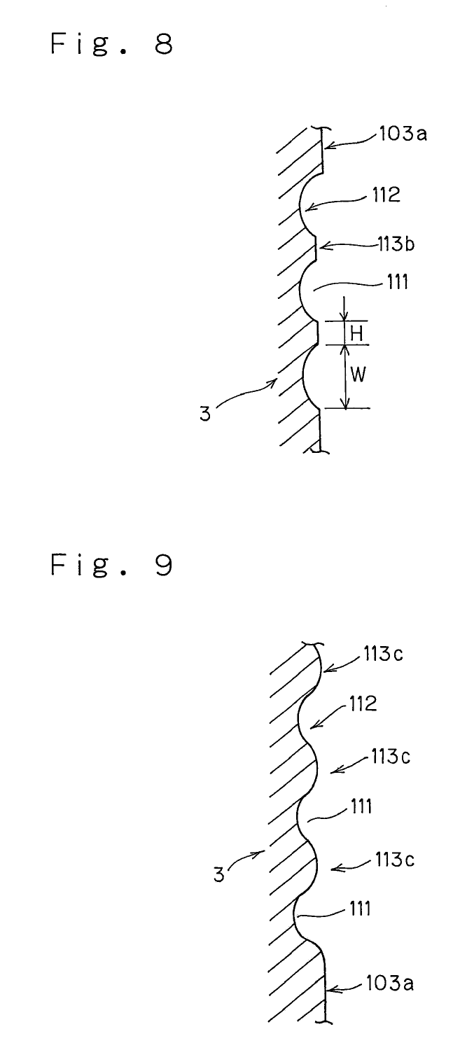

Furthermore, as with projecting portions 113c shown in FIG. 9, elongated recesses 111 may be such that projecting portions are formed by curved surfaces so that external surfaces of side wall portions 3 are formed into an irregular shape like a corrugated sheet.

In any case, the bottom surface portions of the curved portions 112 are made up of the specular surface whose Ra is in the range of 0.4 to 1.5 μm, and the edge portions of the curved portions other than the specular surface portions and the aforesaid projecting portions 113a, 113b, 113c are made up of the rough surface whose Ra exceeds 1.5 μm.

In addition, while the elongated recesses 111 shown in FIG. 5 are illustrated as being arranged in parallel and concentrically along the circumferential direction of the side wall portion 3, the elongated recesses 111 may be arranged in the radial direction of the tire (a direction at right angles to the direction shown in FIG. 5) or may be arranged obliquely relative to the radial direction. However, the elongated recesses 111 are preferably arranged concentrically along the circumferential direction so as to ease the maintenance work such as re-polishing for removing scale deposited on the mold.

There is no specific limitation imposed on the area where the elongated recesses 111 are formed, and hence, the elongated recesses 111 may be formed circumferentially continuously or discontinuously along the full circumference of the side wall portion 3. Alternatively, the elongated recesses 111 may be provided entirely or partially on the side wall portion 3 in the radial direction of the tire, and when they are provided partially, the elongated recesses 111 may be provided, for example, only in portions where markings 110 are shown.

In addition, markings 110 are shown on the tire T3 which are made up of letters, numbers and symbols which show a manufacturer, a trade name, a tire size and the like, as well as graphics which are design patterns which show a rotational direction of the tire and dress up the sides of the tire. In FIG. 5, as the markings 110, a line of letters (TOYO) is shown in the form of carved letters.

The markings 110 are defined, as shown in FIG. 10 (a vertical sectional portion of a letter, “O”), by projecting planes which are provided to project axially outwards of the tire from the surface of the elongated recess 111 formed area 103b with the elongated recess formed area 103b functioning as a background portion which enhances the visibility of the markings 110.

The surfaces of the projecting planes of the markings 110 are made up of a rough surface whose Ra exceeds 1.5 μm. By this configuration, the surfaces of the markings 110 which are made up of the rough surface having the different glossiness from that of the specular surfaces which are made up of the curved portions 112 of the elongated recesses 111 are made to look as if they stood out relative to the specular surfaces, thereby making it possible to increase the visibility thereof.

The projecting height of the markings 110 may be made equal to the height of the side wall surface 103a or made to project further outwards on the order of 0.5 to 3.0 mm than the side wall surface 103a depending upon tire sizes and types (letters, designs and the like) of markings. However, in the event that the projecting height exceeds 3.0 mm, the surfaces of the markings becomes easy to be subjected to exterior damage, and cracks are easily generated in edge portions of the portions where the markings 110 are provided to project therefrom due to the concentration of stress thereat, and hence, the projecting height exceeding 3.0 mm is not preferable.

Note that while in this embodiment, the line of letters, “TOYO,” is shown by solid letters which have no rim provided along perimeters thereof, the letters may, of course, be shown by rimmed letters.

### Fourth Embodiment

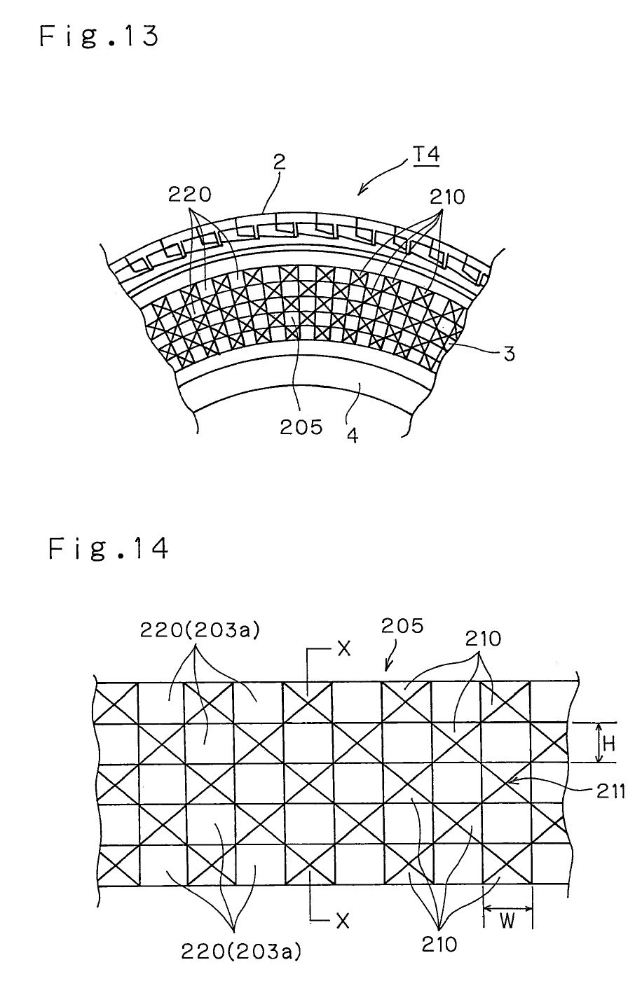

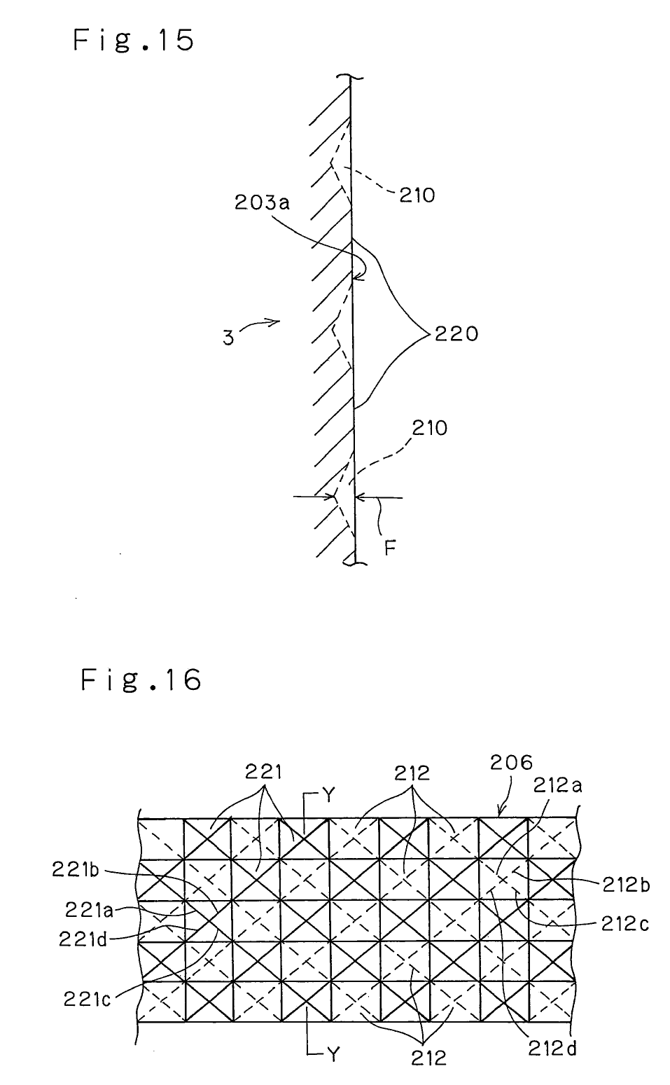

FIG. 13 is a side view of a tire which shows a side wall surface of a pneumatic tire T4 which constitutes a fourth embodiment of the invention, FIG. 14 is a partially enlarged view of FIG. 13, and FIG. 15 is a partial sectional view taken along the line X-X in FIG. 14. In FIGS. 14, 15, a curved plane on the side wall surface is illustrated as being deployed into a flat plane as a matter of convenience.

The tire T4 is made up of a tread portion 2, side walls 3 which extends radially inwards from both edges of the tread portion 2, and bead portions 4 which continue to inner edges of the side walls 3 and which are secured to rim flanges.

An irregular portion 205 is formed on external surfaces of the side wall portions 3 of the tire T4 in which recessed portions 210 and projecting portions 220 are provided alternately and repeatedly in such a manner as to lie adjacent to each other.

In the tire T4, the irregular portion 205 is made up of lines of recessed portions 210 and projecting portions 220 or valleys and peaks of the same configuration and the same dimensions which are aligned alternately in the circumferential direction, and the lines of recessed portions and projecting portions 220 are aligned concentrically along the circumferential direction of the tire while forming a checkered pattern in which the projecting portions 220 surround the recessed portions 210.

In the tire T4, the recessed portion 210 is formed into the shape of a quadrangular pyramid-like valley which is recessed from a reference plane 203a of the side wall portion 3.

In addition, the projecting portion 220 is made up of the reference plane 203a which constitutes an external surface of the side wall portion 3, and the projecting portion 220 is defined by a flat plane and is formed into the shape of a quadrangular tableland relative to the recessed portion 210. No specific limitation is imposed on the dimensions of the recessed portion 210 and the projecting portion 220. However, the following dimensions are preferable from the viewpoint of tire properties and maintenance of safety. Namely, a circumferential width W thereof is in the range of the order of 0.5 to 20 mm and preferably in the range of the order of 0.5 to 15 mm, and a radial height H thereof is in the range of the order of 0.3 to 15 mm and preferably in the range of the order of 0.5 to 12 mm. In addition, a depth (or a height) F thereof is in the range of the order of 0.2 to 5 mm and preferably in the range of 0.3 to 3 mm.

In addition, an area where the recessed portions 210 are formed is preferably made to occupy 20 to 80% of an area where the irregular portion 205 is formed, and FIG. 14 shows a case where the recessed portion formed area occupies 50% of the irregular portion formed area. In the event that the ratio of the recessed portion 210 formed area to the irregular portion formed area is out of the range of 20 to 80%, specular surfaces (glossy portions) or rough surfaces (non-glossy portions) of the irregular portion 205 become uneven, whereby the effect of increased visuality is lost.

An inner circumferential surface of the recessed portion 210 is formed into a specular surface whose surface has a center line average surface roughness (Ra) of 0.4 to 1.5 μm. This specular surface formed area may extend over the whole of the inner circumferential surface of the recessed portion 210 or may be limited to part thereof which is centered at an apex 211 of the recessed portion 210. In the event that the specular surface is formed partially, with a view to securing the glossiness of the recessed portion 210, the specular surface formed area should be 50% or more of an inner circumferential surface area of the recessed portion which includes the apex 211, preferably 60% or more and more preferably 70% or more.

Although the Ra of the specular surface is set to the range of 0.4 to 1.5 μm, in the event that the Ra is less than 0.4 μm, the light reflectiveness at the recessed portions 210 becomes too large and hence they tend to glitter to thereby look white, so as to decrease the visible appearance of the side wall portion 3 unintentionally. In addition, although mud, oil or the like becomes easy to wash out when they adhere to the surfaces of the recessed portions 210, small exterior damage such as a scratch or scrape produced by scratching or scraping by a curb becomes conspicuous. Furthermore, a special surface treatment (for example, a surface treatment by plating with chrome or the like) is necessary to be made on a tire molding mold, which is not preferable because the tire production costs are increased. In contrast, in the event that the Ra exceeds 1.5 μm, minute foreign particles such as dust or dirt such as oil enters fine irregularities on the surfaces, and once they so enter, dust and dirt become hard to wash out and hence continue to remain on the surfaces, whereby the visible appearance is deteriorated.

Additionally, the peripheral area including the projecting portions 220 which surround the specular surface of the recessed portion 210 is made up of a rough surface in which Ra exceeds 1.5 μm. The difference in Ra between the specular surface and the rough surface is preferably 1 μm or more, so that a difference in glossiness is exhibited therebetween so as to enhance the visibility of the side wall portion 3, thereby making it possible to increase the visible appearance of the tire effectively.

In the event that the Ra of the rough surface exceeds 5 μm, the surface gets satinized remarkably and the irregularity on the rubber surface is increased to facilitate the intrusion of much dust thereinto. In addition, once oil or the like comes to adhere thereto, it becomes hard to wash out, and the remaining oil or the like constitutes a cause for deterioration of the visible appearance. Furthermore, the filthy surface also gets disadvantageous with respect to resistance to ozone, facilitating the generation of ozone cracks through service over a long period of time.

There is no specific limitation imposed on the area where the irregular portion 205 is formed, and hence, the irregular portion 205 may be formed circumferentially continuously or discontinuously along the full circumference of the side wall portion 3. Alternatively, the irregular portion 205 may be provided entirely or partially on the side wall portion 3 in the radial direction of the tire.

In addition, the recessed portions 210 and the projecting portions 220 may be such that recessed portions and projecting portions of the same configuration are arranged in such a way as described above or recessed portions and projecting portions of different configurations are combined and furthermore are arranged at random. Alternatively, the recessed portions 210 and the projecting portions 220 may be such that their dimensions are sequentially increased or decreased towards the radial direction of the tire. In addition, although the irregular portion may be such that elongated recesses and elongated projections, which are made up of straight lines or curved lines, are disposed alternately, the configuration illustrated in the figures in which the valleys and peaks are arranged alternately and repeatedly is preferable because the effect in changing the light reflectiveness is increased.

According to the tire T4 of the invention which is configured as has been described heretofore, the specular surfaces and the rough surfaces are made to appear alternately and repeatedly in such a manner as to be adjacent to each other, whereby the light reflectiveness is changed by the difference in glossiness therebetween to thereby increase the visuality of the tire, and hence, the tire which has a superior visible appearance is provided.

Furthermore, markings can also be shown on the irregular portion 205 which are made up of letters, numbers and symbols which indicate a manufacturer, a trade name, a tire size and the like, as well as graphics such as design patterns which indicate a rotational direction of the tire and dress up the sides of the tire.

The glossiness of the recessed portions 210 and the rough surfaces which make up the projecting portions 220 can be formed by a tire vulcanization mold provided with a surface roughness Ra which is substantially equal to the roughness of the surfaces of the tire, and the Ra of the molding surface of the mold can be adjusted by the use of a known method such as the shot blast method, the specular surface polishing method or a combination thereof.

In addition, since portions of tire mold which correspond to the recessed portions 210 are formed into a projecting shape, polishing work becomes easy to be carried out on the surfaces of the portions concerned of the mold, and furthermore, maintenance work is facilitated which includes a re-polishing for removing scale of parting agent which deposits on the surface of the mold through vulcanization molding of a tire. Thus, an increase in tire productivity and maintenance efficiency can be realized.

Hereinafter, modified examples 1 to 4 made to the configurations of the recessed portion and projecting portion of the irregular portion will be described.

### Modified Example 1

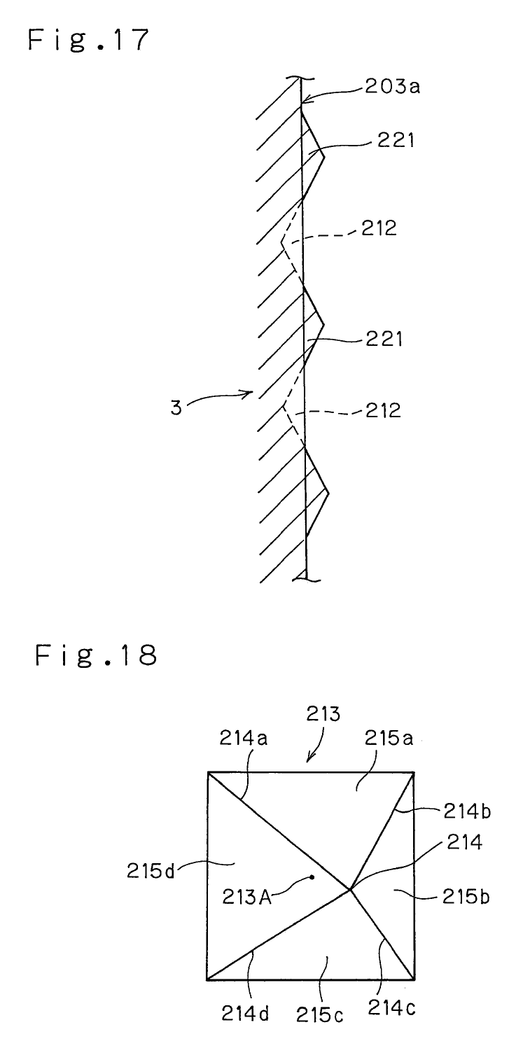

In an irregular portion 206 shown in FIG. 16, as with the irregular portion 205, a recessed portion 212 is provided in such a manner as to be recessed from a side wall surface 203a into a quadrangular pyramid shape. (Ridges 212a, 212b, 212c, 212d of the quadrangular pyramid are indicated by solid lines.) In addition, a projecting portion 221 is provided in such a manner as to project from the side wall surface 203a into a quadrangular pyramid shape. (Ridges 221a, 221b, 221c, 221d of the quadrangular pyramid are indicated by solid lines.) A sectional view taken along the line Y-Y in FIG. 16 is shown in FIG. 17. An inner circumferential surface of the recessed portion 212 is formed into a specular surface whose surface has an Ra of 0.4 to 1.5 μm, and a peripheral area including the projecting portions 22 which surround the specular surface of the recessed portion 212 is made up of a rough surface whose surface has an Ra of more than 1.5 μm.

### Modified Example 2

As with the irregular portion 205, a recessed portion 213 shown in FIG. 18 (an enlarged view of a single recessed portion being shown) is provided in such a manner as to be recessed from a side wall surface 203a into a quadrangular pyramid shape, and a projecting portion is defined by the side wall surface 203a. As is shown in the figure, an apex 214 of the quadrangular pyramid is located in an eccentric position which deviates from a center 213A of the recessed portion 213. By this configuration, ridges 214a, 214b, 214c, 214d of the quadrangular pyramid have different lengths, and inner circumferential planes 215a, 215b, 215c, 215d which are defined by four sides and the ridges 214a, 214b, 214c, 214d of the recessed portion 213 have different slopes.

The inner circumferential surface of the recessed portion 213 is formed into a specular surface whose surface has an Ra of 0.4 to 1.5 μm, and the visibility is increased by diffuse reflection of light thereon, thereby making it possible to increase the visible appearance of the tire.

The apex of the recessed portion 213 may be set in the same position over a plurality of recessed portions 213 or the individual recessed portions 213 may be set to have different apex positions.

### Modified Example 3

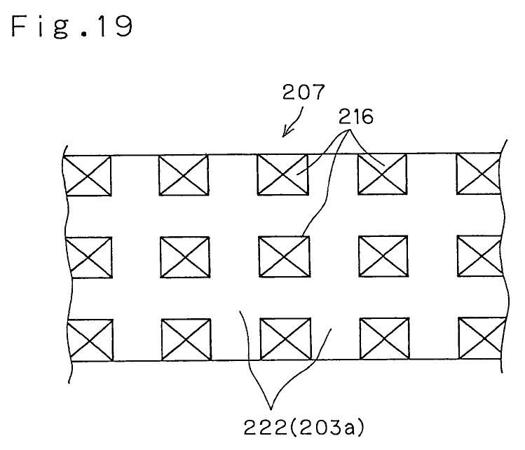

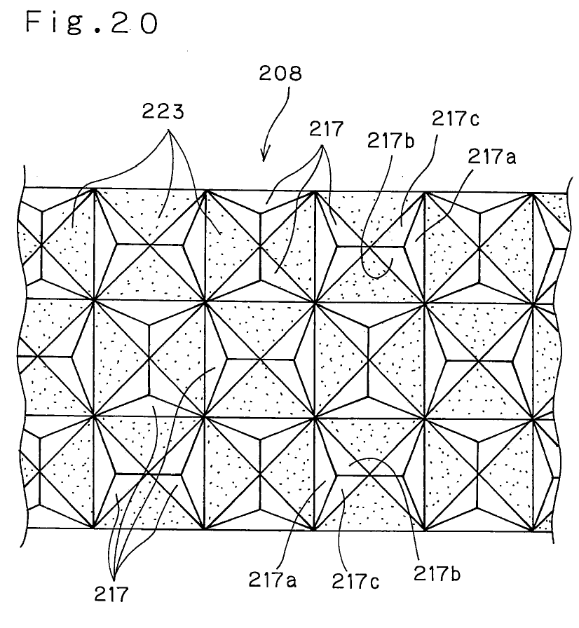

In an irregular portion 207 shown in FIG. 19, as with the irregular portion 205, a recessed portion 216 is provided in such a manner as to be recessed from a side wall surface 203a into a quadrangular pyramid shape, and a projecting portion 222 is defined by the side wall surface 203a. As is shown in the figure, the area of recessed portions 216 occupies 25% of the irregular portion 207. In the event that the area occupied by the recessed portions 206 becomes less than 20% of the irregular portion 207, the area of specular surfaces is decreased and the light reflectiveness becomes insufficient, whereby a sufficient increase in the visible appearance of the tire cannot be obtained. In contrast to this, when the area of recessed portions 216 exceeds 80%, reflected light becomes more than required and the side wall surfaces tend to glitter excessively, which sometimes deteriorates the visible appearance of the tire.

### Modified Example 4

While in the embodiments, the irregular portions are described as being made up of quadrangular pyramids, an irregular portion 208 shown in FIG. 20 has a combination of the recessed portions 217 which are made up of triangular pyramids each defined by three flat sloping planes 217a, 217b, 217c each having a specular surface, and the projecting portions 223 which are each made up of a rough surface in the triangular flat plane portion, which exhibits a so-called “scale pattern” is shown.

The configurations of the recessed portions and the projecting portions which make up the irregular portion are not limited to quadrangle and triangle which were used in the embodiments, and hence, regular polygons such as pentagon and hexagon, their scalene forms, rhombus, circle, ellipse and the like may be used. Moreover, a plurality of shapes such as those described above may be combined together for use.

### EXAMPLES

Hereinafter, the invention will be described specifically based on examples, however, the invention is not limited by those examples.

### First Example

A rubber composition for side wall according to a formulation, which will be described below, was conventionally kneaded and prepared using a Banbury type mixer having a capacity of 200 liters.

### [Rubber Composition for Side Wall]

•natural rubber (50 parts by weight: RSS #3 made in Thailand), •butadiene rubber (50 parts by weight: BR150B by UBE KOSAN Inc.), •carbon black FEF (60 parts by weight: SEAST SO by Tokai Carbon Inc.), •aromatic oil (10 parts by weight: X-140 by Japan Energy Inc.), •paraffin wax (2 parts by weight: OZOACE-0355 by NIHON SEIRO Inc.), •aging preventive agent 6C (2 parts by weight: NOCRAC 6C by OUCHI SHINKO CHEMICAL INDUSTRY Inc.), •stearic acid (2 parts by weight: LUNAC S-20 by KAO Inc.), •zinc oxide (3 parts by weight: AENKA 1 by MITSUI KINZOKU KOGYO Inc.), •sulfur (2 parts by weight: 5% oil treated powder sulfur by HOSOI CHEMICAL INDUSTRY Inc.), •vulcanization promoter (1.5 parts by weight: NOCCELER NS-P by OUCHI SHINKO CHEMICAL INDUSTRY Inc.)

Radial tires of 225/45R 17 were prepared in which the rubber composition so obtained was applied to side wall portions. Sample tires were vulcanization molded under the same vulcanizing condition using a steel side wall molding mold and a surface roughness of a molding surface for molding marking areas on side walls was adjusted by the known shot blast method and specular surface polishing method so that Ra fell within a predetermined range. The marking area was made up of the marking letters and the background portion which was plain or provided with ridges shown in FIG. 1.

Example 1 and Comparison Examples 1, 2, 4 had the marking area cross section shown in FIG. 2A, and Example 2 had the marking area cross section shown in FIG. 4A. In the tire of Comparison Example 2, the marking letters were satinized, and ridges of a triangular cross section were provided in the background portion in such a manner as to extend rectilinearly in parallel at peak-to-peak intervals of 2.5 mm while being inclined at 20 degrees relative to the radial direction of the tire, and the marking letters and the background portion were provided in the marking area. In addition, in the tire of Comparison Example 3, the marking area was provided on the flat plane on the side wall surface, and the marking letters were provided in such a manner as to project from the side wall surface.

The surface roughnesses Ra of the sample tires were measured by the following method, and following this, the sample tires were evaluated by the following methods with respect to marking visibility, visible appearance of the tire before use, visible appearance of the tire after use on a vehicle actually driven, visible appearance after contact with a curb, and visible appearance after use on an ozone illumination drum actually rotated. The results are shown in Table 1.

### [Surface Roughness Ra]

Center line average surface roughnesses Ra of the marking portions and the background portions of the sample tires were measured according to the JIS B0601 method using a contact profile meter E-35A by TOKYO SEIMITSU Inc.

### [Marking Visibility]

The side walls of the tires were visually observed by a panel of 10 people. The visibility of the markings were subjected to organoleptic evaluations using a 5-point evaluation method, and the results of the evaluations averaged out to be rounded to the nearest whole number, the results thereof being shown in Table 1. A larger number indicates a better quality.

### [Visible Appearance Before Use]

The sample tires were set on JIS specified rims (with an internal pressure of 220 kPa). Visible appearances of the side wall portions were visually observed and were evaluated in the organoleptic fashion using the 5-point evaluation method. A larger number indicates a better quality.

[Visible Appearance after Use on Actually Driven Vehicle]

The sample tires were set on JIS specified rims (with an internal pressure of 220 kPa) and were then fitted on a domestic passenger vehicle of an engine displacement of 2500 cc for an actual running of 3000 km on a general road finished with a dry asphalt road surface. The marking areas were visually observed after use on the vehicle actually so driven and evaluated in the organoleptic fashion for 5-point evaluation. A larger number indicates a better quality.

[Visible Appearance after Contact with Curb]

The sample tires were set on JIS specified rims (with an internal pressure of 220 kPa) and then fitted on a domestic passenger vehicle of an engine displacement of 2500 cc. Then, the vehicle was driven at a vehicle speed of 5 km/h to bring the front tire into contact with a concrete curb at a contact angle of 5 degrees and thereafter, the vehicle was moved 50 cm. Visible appearances of the marking areas of the sample tires were then visually observed and evaluated in the organoleptic fashion for 5-point evaluation. A larger number indicates a better quality.

[Visible Appearance after Use on Ozone Illumination Drum]

The sample tires were set on JIS specified rims (with an internal pressure of 220 kPa), and a JIS maximum load was exerted on the tires. The tires were rotated on a drum testing machine at 30 km/h for 3 weeks in an atmosphere where ozone concentration was 80 pphm and the temperature was 38° C. Thereafter, the tires were visually observed with respect to ozone crack generation in the marking areas and evaluated in the organoleptic fashion for 5-point evaluation. A larger number indicates a better quality.

TABLE 1

| | COMPARISON | COMPARISON | COMPARISON | | | |
|---|---|---|---|---|---|---|
| MARKING AREA | EXAMPLE 1 | EXAMPLE 2 | EXAMPLE 3 | EXAMPLE 1 | EXAMPLE 2 | EXAMPLE 4 |
| MARKINGS (LETTERS) | SATINIZED | SATINIZED | SPECULAR | SPECULAR | ROUGH | SPECULAR |
| | | | SURFACE | SURFACE | SURFACE | SURFACE |
| MARKINGS (LETTERS) | 2.0 | 2.0 | 0.5 | 0.5 | 1.7 | 0.6 |
| Ra (μm) | | | | | | |
| BACKGROUND PORTION | SATINIZED | RIDGES | ROUGH | ROUGH | SPECULAR | ROUGH |
| (PLAIN) | | | SURFACE | SURFACE | SURFACE | SURFACE |
| BACKGROUND PORTION | 2.0 | 2.0 | 1.7 | 1.7 | 0.5 | 2.0 |
| (PLAIN) (Ra) (μm) | | | | | | |
| MARKING AREA DEPTH (mm) | 1.0 | 1.0 | 0 | 1.0 | 1.0 | 1.0 |
| MARKING AREA WIDTH (mm) | 50 | 30 | 30 | 30 | 30 | 30 |
| REFERENCE DIAGRAMS; | FIG. 2A | FIG. 2A | — | FIG. 2A | FIG. 4A | FIG. 2A |
| MARKING VISIBILITY | 2 | 4 | 3 | 5 | 5 | 5 |
| VISIBLE APPEARANCE AFTER | 2 | 1 | 4 | 4 | 4 | 4 |
| RUNNING | | | | | | |
| VISIBLE APPEARANCE AFTER | 2 | 4 | 1 | 5 | 5 | 5 |
| CONTACT WITH CURB | | | | | | |
| VISIBLE APPEARANCE AFTER | 2 | 4 | 4 | 4 | 4 | 2 |
| OZONE ILLUMINATION | | | | | | |

As is shown by the results indicated on Table 1, it is seen that with the tires of Examples 1, 2 according to the invention, not only could superior marking visibility be obtained but also dirt as a result of the actual driving was hard to adhere to the marking areas and exterior damage such as marring given by the curb was made as small as possible. Furthermore, it is seen that the resistance to ozone crack could be improved by making the surface roughness smaller than that of the conventional satinized area (Comparison Example 1). Thus, it is seen that the visibility of the markings can be maintained in good conditions over a long period of time by the enhancement in visible appearance attained according to the invention.

### Second Example

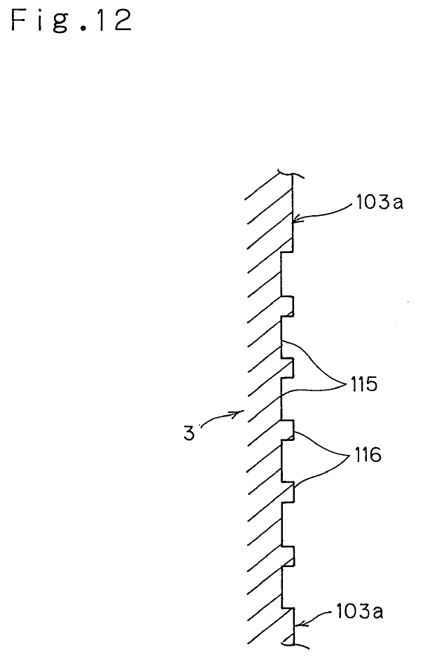

Radial tires of 225/45R17 were produced according to specifications shown in Table 2 as sample tires. In the sample tires, the rubber composition for the side wall obtained as described above was applied to the side wall portions, and eight elongated recesses having the cross sections shown in FIGS. 6, 7 were provided in such a manner as to extend on the side wall portion shown in FIG. 5 in the circumferential direction, and marking letters (TOYO) were provided in the elongated recess formed area. Sample tires were vulcanization molded under the same vulcanizing condition to form specular surfaces and satins (rough surfaces) using a steel side wall molding mold and a surface roughness of a molding surface for molding marking areas on the side walls was adjusted by the known shot blast method and specular surface polishing method so that Ra of the curved portions (areas corresponding to 90% of the width thereof) of the elongated recesses and Ra of the side wall external surface other than the curved portions fell within predetermined ranges. In addition, in Comparison Example 5, conventional ridges 14 shown in FIG. 11 were formed at peak-to-peak intervals of 2.0 mm, and the surface was satinized, in Comparison Example 6, the side wall external surfaces were satinized, and the marking letters were provided in such a manner as to project from the side surface to a height of 1 mm, and in Comparison Example 10, the elongated recesses shown in FIG. 12 were formed to an irregular portion made up of recessed profiles 115 and projecting profiles 116, and the bottom surfaces of the elongated recesses were made up of specular surfaces.

The surface roughnesses Ra of the specular surface portion and the rough surface portion (including the markings) on the side wall external surface were measured using the method described above, and following this, the sample tires were evaluated by the aforesaid methods with respect to marking visibility, visible appearance of the tire after use on an actually driven vehicle, visible appearance after contact with a curb, and visible appearance after use on an ozone illumination drum. The results are shown in Table 2.

TABLE 2

| | COMPARISON | COMPARISON | COMPARISON | COMPARISON |
|---|---|---|---|---|
| | EXAMPLE 5 | EXAMPLE 6 | EXAMPLE 7 | EXAMPLE 8 |
| ELONGATED | | | | |
| RECESSES | | | | |
| ELONGATED RECESS | RIDGES | NONE | CURVED | CURVED |
| CONFIGURATION | | | | |
| SURFACE PROPERTIES | SATINIZED | SATINIZED | SPECULAR | SPECULAR |
| | | | SURFACE | SURFACE |
| SURFACE PROPERTIES | 2.0 | 2.0 | 0.5 | 0.5 |
| (Ra) (μm) | | | | |
| SURFACE PROPERTIES | 1.0 | — | 1.0 | 1.0 |
| DEPTH (mm) | | | | |
| SURFACE PROPERTIES | 2 | — | 5 | 40 |
| WIDTH (mm) | | | | |
| PROJECTING PORTION | 0 | — | 0 | 0 |
| WIDTH (mm) | | | | |
| SIDE PORTION OTHER | | | | |
| THAN ELONGATED | | | | |
| RECESSES, MARKINGS | | | | |
| SURFACE PROPERTIES | SATINIZED | SATINIZED | SPECULAR | SATINIZED |
| | | | SURFACE | |
| SURFACE PROPERTIES | 2.0 | 2.0 | 0.5 | 2.0 |
| (Ra) (μm) | | | | |
| REFERENCE | FIG. 11 | — | FIG. 6 | FIG. 6 |
| DIAGRAMS | | | | |
| MARKING VISIBILITY | 4 | 2 | 2 | 5 |
| VISIBLE APPEARANCE | 1 | 2 | 4 | 4 |
| AFTER RUNNING | | | | |
| VISIBLE APPEARANCE | 4 | 2 | 2 | 2 |
| AFTER CONTACT WITH | | | | |
| CURB | | | | |
| VISIBLE APPEARANCE | 3 | 3 | 4 | 4 |
| AFTER OZONE | | | | |
| ILLUMINATION | | | | |

| | COMPARISON | COMPARISON | | |
|---|---|---|---|---|
| | EXAMPLE 9 | EXAMPLE 10 | EXAMPLE 3 | EXAMPLE 4 |
| ELONGATED | | | | |
| RECESSES | | | | |
| ELONGATED RECESS | CURVED | RECESSED | CURVED | CURVED |
| CONFIGURATION | | PROFILE | | |
| SURFACE PROPERTIES | SATINIZED | SPECULAR | SPECULAR | SPECULAR |
| | | SURFACE | SURFACE | SURFACE |
| SURFACE PROPERTIES | 2.0 | 0.5 | 0.5 | 0.5 |
| (Ra) (μm) | | | | |
| SURFACE PROPERTIES | 1.0 | 1.0 | 1.0 | 1.0 |
| DEPTH (mm) | | | | |
| SURFACE PROPERTIES | 5 | 5 | 5 | 5 |
| WIDTH (mm) | | | | |
| PROJECTING PORTION | 0 | 2 | 0 | 2 |
| WIDTH (mm) | | | | |
| SIDE PORTION OTHER | | | | |
| THAN ELONGATED | | | | |
| RECESSES, MARKINGS | | | | |
| SURFACE PROPERTIES | SPECULAR | SATINIZED | SATINIZED | SATINIZED |
| | SURFACE | | | |
| SURFACE PROPERTIES | 0.5 | 2.0 | 2.0 | 2.0 |
| (Ra) (μm) | | | | |
| REFERENCE | FIG. 6 | FIG. 12 | FIG. 6 | FIG. 7 |
| DIAGRAMS | | | | |
| MARKING VISIBILITY | 4 | 4 | 5 | 5 |
| VISIBLE APPEARANCE | 4 | 3 | 4 | 4 |
| AFTER RUNNING | | | | |
| VISIBLE APPEARANCE | 2 | 5 | 5 | 5 |
| AFTER CONTACT WITH | | | | |
| CURB | | | | |
| VISIBLE APPEARANCE | 4 | 3 | 4 | 4 |
| AFTER OZONE | | | | |
| ILLUMINATION | | | | |

As is shown by the results indicated on Table 2, it is seen that with the tires of Examples 3, 4 according to the invention, not only could superior marking visibility be obtained but also dirt adhering to the marking areas as a result of the actual driving was made as small as possible and exterior damage such as marring given by the curb was made as small as possible. Furthermore, it is seen that the resistance to ozone crack could be improved by making the surface roughness smaller than that of the conventional satinized area. Thus, it is seen that the visibility of the markings can be maintained in good conditions over a long period of time by the enhancement in visible appearance attained according to the invention. In addition, by forming the elongated recesses into the curbed shape, compared with Comparison Example 10 which was made up of the elongated recesses of angularly recessed profiles, the marking visibility and the visible appearance after actual running and running under ozone illumination can be increased.

### Third Example

Radial tires of 225/45R17 were produced according to specifications shown in Table 3 as sample tires. In the sample tires, the rubber composition for side wall obtained as described above was applied to the side wall portions, and an irregular portion made up of checkered patterns was provided in such a manner as to extend on the side wall portion shown in FIG. 13 in the circumferential direction. Sample tires were vulcanization molded under the same vulcanizing condition using a steel side wall molding mold and a surface roughness of a molding surface for molding marking areas on the side walls was adjusted by the known shot blast method and specular surface polishing method so that Ra for portions where specular surfaces were to be formed and Ra for portions where rough surfaces (satins) were to be formed fell within predetermined ranges. In addition, the whole inner circumferential surface of the recessed portion was made into the specular surface. Comparison Example 11 was a conventional tire in which side wall portions were made up of satinized flat planes with no irregular portion formed thereon.

The sample tires were evaluated by the aforesaid methods with respect to surface roughnesses Ra of the specular surface portion and the other remaining rough surface portion, visible appearance of the tire before use, visible appearance of the tire after use on an actually driven vehicle, visible appearance after contact with a curb, and visible appearance after use on an ozone illumination drum. The visible appearance of the tire before use was also evaluated by the aforesaid method. The results are shown in Table 3.

TABLE 3

| | COMPARISON | | | | |
|---|---|---|---|---|---|
| | EXAMPLE 11, | EXAMPLE 5 | EXAMPLE 6 | EXAMPLE 7 | EXAMPLE 8 |
| RECESSED PORTIONS | NONE | | | | |
| RECESSED PORTION | FLAT PLANE | QUADRANGULAR | QUADRANGULAR | QUADRANGULAR | QUADRANGULAR |
| CONFIGURATION | | PYRAMID | PYRAMID | PYRAMID | PYRAMID |
| SURFACE PROPERTIES | SATINIZED | SPECULAR | SPECULAR | SPECULAR | SPECULAR |
| | | SURFACE | SURFACE | SURFACE | SURFACE |
| SURFACE PROPERTIES | 2.0 | 0.5 | 0.5 | 0.5 | 0.5 |
| (Ra) (μm) | | | | | |
| SURFACE PROPERTIES | — | 0.5 | 0.5 | 0.5 | 0.5 |
| DEPTH (mm) | | | | | |
| SURFACE PROPERTIES | — | 10 | 10 | 10 | 10 |
| WIDTH (mm) | | | | | |
| SURFACE PROPERTIES | — | 10 | 10 | 10 | 10 |
| HEIGHT (mm) | | | | | |
| APEX POSITION | — | CENTER | CENTER | DEVIATED | CENTER |
| OCCUPIED AREA (%) | — | 50 | 50 | 50 | 75 |
| PROJECTING PORTION | NONE | | | | |
| PROJECTING PORTION | FLAT PLANE | FLAT PLANE | QUADRANGULAR | FLAT PLANE | FLAT PLANE |
| CONFIGURATION | | | PYRAMID | | |
| SURFACE PROPERTIES | SATINIZED | SATINIZED | SATINIZED | SATINIZED | SATINIZED |
| SURFACE PROPERTIES | 2.0 | 2.0 | 2.0 | 2.0 | 2.0 |
| (Ra) (μm) | | | | | |
| SURFACE PROPERTIES | — | — | 0.5 | — | — |
| APEX HEIGHT (mm) | | | | | |
| SURFACE PROPERTIES | — | — | 10 | — | — |
| WIDTH (mm) | | | | | |
| SURFACE PROPERTIES | — | — | 10 | — | — |
| HEIGHT (mm) | | | | | |
| REFERENCE DIAGRAMS | — | FIG. 14 | FIG. 16 | FIG. 18 | FIG. 19 |
| VISIBLE APPEARANCE | 2 | 4 | 5 | 5 | 5 |
| BEFORE USE | | | | | |
| VISIBLE APPEARANCE AFTER | 2 | 4 | 4 | 4 | 4 |
| RUNNING | | | | | |
| VISIBLE APPEARANCE AFTER | 4 | 4 | 4 | 4 | 4 |
| CONTACT WITH CURB | | | | | |
| VISIBLE APPEARANCE AFTER | 3 | 4 | 4 | 4 | 4 |
| OZONE ILLUMINATION | | | | | |

| | | COMPARISON | COMPARISON | COMPARISON |
|---|---|---|---|---|
| | EXAMPLE 9 | EXAMPLE 12 | EXAMPLE 13 | EXAMPLE 14 |
| RECESSED PORTIONS | | | | |
| RECESSED PORTION | TRIANGULAR | QUADRANGULAR | QUADRANGULAR | QUADRANGULAR |
| CONFIGURATION | PYRAMID | PYRAMID | PYRAMID | PYRAMID |
| SURFACE PROPERTIES | SPECULAR | SATINIZED | SATINIZED | SPECULAR |
| | SURFACE | | | SURFACE |
| SURFACE PROPERTIES | 0.5 | 2.0 | 2.0 | 0.5 |
| (Ra) (μm) | | | | |
| SURFACE PROPERTIES | 0.5 | 0.5 | 0.5 | 0.5 |
| DEPTH (mm) | | | | |
| SURFACE PROPERTIES | 10 | 10 | 10 | 10 |
| WIDTH (mm) | | | | |
| SURFACE PROPERTIES | 5 | 10 | 10 | 10 |
| HEIGHT (mm) | | | | |
| APEX POSITION | CENTER | CENTER | CENTER | CENTER |
| OCCUPIED AREA (%) | 50 | 50 | 50 | 15 |
| PROJECTING PORTION | | | | |
| PROJECTING PORTION | FLAT PLANE | FLAT PLANE | FLAT PLANE | FLAT PLANE |
| CONFIGURATION | | | | |
| SURFACE PROPERTIES | SATINIZED | SATINIZED | SPECULAR | SATINIZED |
| | | | SURFACE | |
| SURFACE PROPERTIES | 2.0 | 2.0 | 0.5 | 2.0 |
| (Ra) (μm) | | | | |
| SURFACE PROPERTIES | — | — | — | — |
| APEX HEIGHT (mm) | | | | |
| SURFACE PROPERTIES | — | — | — | — |
| WIDTH (mm) | | | | |
| SURFACE PROPERTIES | — | — | — | — |
| HEIGHT (mm) | | | | |
| REFERENCE DIAGRAMS | FIG. 20 | FIG. 14 | FIG. 14 | FIG. 19 |
| VISIBLE APPEARANCE | 4 | 3 | 4 | 3 |
| BEFORE USE | | | | |
| VISIBLE APPEARANCE AFTER | 4 | 3 | 3 | 3 |
| RUNNING | | | | |
| VISIBLE APPEARANCE AFTER | 4 | 4 | 2 | 4 |
| CONTACT WITH CURB | | | | |
| VISIBLE APPEARANCE AFTER | 4 | 3 | 3 | 4 |
| OZONE ILLUMINATION | | | | |

As is shown by the results indicated on Table 3, it is seen that with the tires of Examples 5 to 9 according to the invention, not only could superior visible appearance before use be obtained but also dirt as a result of the actual driving was hard to adhere to the marking areas and exterior damage such as marring given by the curb was made as small as possible. Furthermore, it is seen that the resistance to ozone crack could be improved. Thus, it is seen that the visible appearance can be maintained in good conditions over a long period of time.

According to the pneumatic tire according to the invention, by producing the difference in glossiness between the markings shown on the side walls and the background portions thereof, the markings are made conspicuous to exhibit the superior visibility. In addition, the adhesion of dust and dirt to the markings is prevented, and the markings are made difficult to be subjected to exterior damage. Furthermore, the resistance to ozone is improved so as to maintain the visible appearance of the tire in good conditions over the long period of time, thereby making it possible for the effect of increased marking visibility to continue over the long period of time. In addition, the maintenance work such as polishing the marking molding surface of the mold is facilitated, thereby making it possible to realize an increase in tire productivity and maintenance efficiency.

Additionally, by making the bottom portions of the plurality of elongated recesses which are formed into the curved shape and aligned in parallel to the side portions the specular surfaces and the other remaining elongated projection formed area the rough surfaces, the glossy portions and the non-glossy portions appear alternately on the external surfaces of the side portions, so that the visuality of the side portions are accentuated. In addition, and the adhesion of dust and dirt to the specular surfaces is prevented, and the specular surfaces are made difficult to be subjected to exterior damage. Furthermore, the resistance to ozone is improved so as to maintain the visible appearance of the tire in good conditions over the long period of time. By providing the markings in the elongated recess formed area, the background of the marking letters is finished with the specular surfaces, whereby the visibility of the markings is increased, and the effect of increased marking visibility can be held over the long period of time.

Furthermore, in the pneumatic tire of the invention, the glossiness of the recessed portions is increased in the irregular portion formed on the side wall portions, whereby the visuality can be increased by changing the light reflectiveness in the irregular portion, thereby making it possible to increase the visible appearance of the tire. Moreover, by adopting the checkered pattern in the arrangement of the irregular portion or imparting the change in slope of the inner circumferential surfaces of the recessed portion so as to produce the difference in glossiness between the recessed portion and the peripheral area which surrounds the recessed portion, the change in reflectiveness is increased, thereby making it possible to enhance the effect of increased visible appearance. In addition, the vulcanization molding mold of the invention, since the portion for molding the recessed portions on the side portions is made into the projecting shape, polishing of the specular surface of the portion concerned is facilitated, and the maintenance work such as re-polishing of the same after use is facilitated, thereby making it possible to realize an increase in tire productivity and maintenance efficiency.

The invention can be applied to pneumatic tires of various sizes and applications which include tires for passenger vehicles and light trucks, and larger tires for buses and heavy trucks.

What is claimed is:

1. A pneumatic tire comprising a specular surface portion having a surface roughness in which a center line average surface roughness (Ra) is in the range of 0.4 to 1.5 μm and a rough surface portion in which an Ra exceeds 1.5 μm, the specular portion and the rough surface portion being provided partially on exterior surfaces of side walls thereof.

2. A pneumatic tire as set forth in claim 1, wherein markings are provided on the side walls, a marking area which includes the marking and a background portion of the marking is formed into a recessed plane which is recessed further inwards than the surface of the side wall in an axial direction of the tire, and the specular surface portion is provided at least in part of the marking area.

3. A pneumatic tire as set forth in claim 2, wherein a surface of the marking comprises the specular surface portion, and the background portion of the marking comprises the rough surface portion.

4. A pneumatic tire as set forth in claim 3, wherein the marking is defined by a projecting plane which is provided in such a manner as to project from the making area which is formed into the recessed plane.

5. A pneumatic tire as set forth in claim 2, wherein a surface of the marking comprises the rough surface portion, and the background portion of the marking comprises the specular surface portion.

6. A pneumatic tire as set forth in claim 5, wherein the marking portion is defined by a projecting plane which is provided in such a manner as to project from the making area which is formed into the recessed plane.

7. A pneumatic tire as set forth in claim 3 or 5, wherein a difference in Ra between the specular surface portion and the rough surface portion is 1 μm or more.

8. A pneumatic tire as set forth in claim 1, wherein a plurality of elongated recesses which continuously extend and each have a curved cross section is formed in such a manner as to be aligned in parallel at least partially on the exterior surfaces of the side walls, at least bottom surfaces of the curved portions comprise the specular surface portion, and the exterior surface of the elongated recess formed area which excludes the specular surface portions comprises the rough surface portion.

9. A pneumatic tire as set forth in claim 8, wherein a difference in Ra between the specular surface portion and the rough surface portion is 1 μm or more.

10. A pneumatic tire as set forth in claim 8 or 9, wherein the plurality of elongated recesses is disposed along a circumferential direction of the side portion of the tire.

11. A pneumatic tire as set forth in claim 8, wherein the marking is provided in the elongated recess formed area.

12. A pneumatic tire as set forth in claim 1, wherein an irregular portion in which recesses and projections are formed alternately is formed at least partially on the exterior surfaces of the side walls, at least part of the surface of the recess comprises the specular surface portion, and a peripheral area which surrounds the specular surface portion comprises the rough surface portion.

13. A pneumatic tire as set forth in claim 12, wherein the projecting portion comprises a reference plane of the side wall, and the recessed portion is recessed from the reference plane.

14. A pneumatic tire as set forth in claim 12 or 13, wherein the irregular portion is arranged in a checkered pattern in which the recessed portions comprise valleys and the projecting portions comprise peaks which surround the valleys.

15. A pneumatic tire as set forth in claim 13, wherein slopes of inner circumferential planes of the recessed portion differ along the circumference of the recessed portion.

16. A pneumatic tire as set forth in claim 12, wherein the specular surface occupies 20 to 80% of the area where the irregular portion is formed.

17. A pneumatic tire as set forth in claim 14, wherein slopes of inner circumferential planes of the recessed portion differ along the circumference of the recessed portion.
